(19) United States
(12) Patent Application Publication
(10) Pub. No.: US 2008/0247853 A1
(43) Pub. Date: Oct. 9, 2008

(54) MULTIFUNCTIONAL BUSHING CONNECTION BETWEEN LIFTGATE PLATFORM AND LOAD TRANSFER MEMBERS

(76) Inventors: Dane W. Gregg, Uniontown, OH (US); Peter J. Savoy, Akron, OH (US)

Correspondence Address: Emerson, Thomson & Bennett, LLC, 777 W. Market Street, Akron, OH, 44303, US

(21) Appl. No.: 11/856,203

(22) Filed: Sep. 17, 2007

Related U.S. Application Data
(60) Provisional application No. 60/825,944, filed on Sep. 18, 2006.

(51) Int. Cl. B60P 1/02

(52) U.S. Cl. 414/545

(57) ABSTRACT

A liftgate platform assembly has increased degrees of freedom with the use of a pivoting ball joint connection.

This application claims priority from U.S. provisional patent application Ser. No. 60/825,944 titled MULTI-FUNCTIONAL BUSHING CONNECTION BETWEEN LIFTGATE PLATFORM AND LOAD TRANSFER MEMBERS filed on Sep. 18, 2006, which is incorporated herein by reference.

### I. BACKGROUND OF THE INVENTION

A. Field of Invention

This invention pertains to the art of methods and apparatuses regarding liftgates and more specifically to methods and apparatuses regarding the attachment of a liftgate platform to the platform support structure.

B. Description of the Related Art

It is well known in the art to attach liftgates to vehicle trailers or other forms of vehicle cargo holds to assist with loading and unloading of the vehicles. In general, liftgates include a platform or deck and some motorized system, often including a hydraulic system, used to move the platform. To load cargo from a ground surface to the vehicle bed, the platform is positioned in a lowered position where it is generally parallel with the ground surface. The cargo can then be easily placed onto the platform. The platform is then lifted to a raised position generally parallel with the vehicle bed. The cargo can then be easily loaded into the vehicle. To unload cargo from the vehicle, the reverse steps are taken.

Various types and styles of liftgates are known in the art. Some non-limiting examples include conventional liftgates, flip-a-way or fold-up liftgates, rail type liftgates, and special purpose liftgates. Generally, each type of liftgate has multiple options including various platform sizes and various load capacities.

FIG. 1 shows a known liftgate assembly 1, a rail type liftgate, including a pair of column or rail members 6, 6 that may be fixedly attached to a corresponding vehicle (not shown) in any conventional manner. The liftgate assembly 1 also may include a pair of runners 8, 8 that can be moved up and down along the rail members 6, 6 in any known manner. The liftgate assembly 1 may also include a platform assembly 2 that has a deck or platform 3 supported to a platform support structure 4 that is in turn supported on the runners 8, 8. The deck or platform 3 may include one or more generally planar sheet or plate members having a traffic surface 11 adapted to receive traffic for loading and unloading cargo. The platform support structure 4 includes multiple brace members 5, which may be tube members as shown, that are assembled together to form a rigid support. The number, orientation, and spacing of brace members 5 will vary depending on the loads the platform assembly 2 is designed to support and the amount of deflection permitted, as will be discussed further below. The platform assembly 2 may be raised and lowered along rails members 6, 6 in any known manner. The platform assembly 2 may also be pivotally attached to the runners 8, 8 so that the platform assembly 2 may be folded up, in direction A1, when not in use and returned to use condition shown in FIG. 1, by pivoting in direction A2. As seen best in FIG. 2, the pivotal connection includes a pivot pin 7 having a close tolerance with the pivot hole into which it is received. A bushing may be used as well. This is the typical pivot connection and while it works well for its intended purpose, it has disadvantages.

With continuing reference to FIGS. 1 and 2, a disadvantage to known liftgate pivot connections is related to the degrees of freedom provided. The platform assembly 2 has only one degree of freedom because it can only freely move in directions A1 and A2 as it pivots about the axis X1 of the pivot pin 7. This single degree of freedom is sufficient as long as the load on the platform assembly 2, which generates a force F1, is relatively small. In cases where the load and the resulting force F1 is relatively large, however, a deflection occurs in the platform assembly 2 and a moment arm generally perpendicular to the axis X1 is produced. The only movement possible in this direction at the pivot pin 7 is based on the elastic deformation of the components. As a result, when the load on the platform assembly 2 is sufficient to deflect the platform assembly 2, the pivot pin 7 and the hole it is received in are subjected to forces that tend to prematurely wear out these components. The known solutions to this problem of increased loading include: (1) making the platform 3 thicker or of stronger material; (2) making the brace members 5 thicker or of stronger material; and, (3) increasing the number of brace members 5. All these solutions have the disadvantages of increased weight and cost.

The present invention provides methods and apparatuses for improving the attachment of a liftgate platform to a platform support structure by increasing the degrees of freedom. This invention, thus, overcomes the foregoing difficulties and others while providing better and more advantageous overall results.

### II. SUMMARY OF THE INVENTION

According to one embodiment of this invention, a liftgate platform assembly has increased degrees of freedom with the use of a pivoting ball joint connection.

According to another embodiment of this invention, a liftgate platform assembly has increased degrees of freedom with the use of a voided bushing.

One advantage of this invention is that, liftgate platform assemblies can be constructed to support increased loads without the need for increased numbers or gauges of components.

Another advantage of this invention is liftgates can be made more economically.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a prior art liftgate assembly.

FIG. 2 is a close of a portion of the liftgate assembly shown in FIG. 1.

FIG. 3 is a perspective close up view of a liftgate assembly including one embodiment of the present invention.

FIG. 4A is a perspective view of a pivoting ball joint connection.

FIG. 4B is a perspective view of the pivoting ball joint connection of FIG. 4A with the ball member angled upward.

FIG. 4B is a perspective view of the pivoting ball joint connection of FIG. 4A with the ball member angled downward.

FIG. 5 is a perspective view similar to that shown in FIG. 3 but with the pivoting ball joint connection angled upward.

FIG. 6 is an elevation view of a voided bushing which may be used according to another embodiment of this invention.

### IV. DETAILED DESCRIPTION OF THE INVENTION

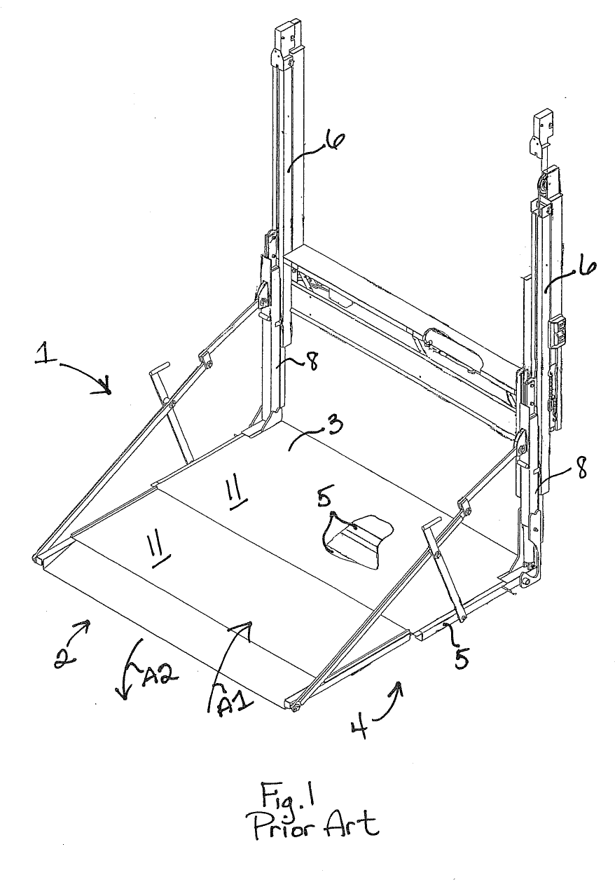

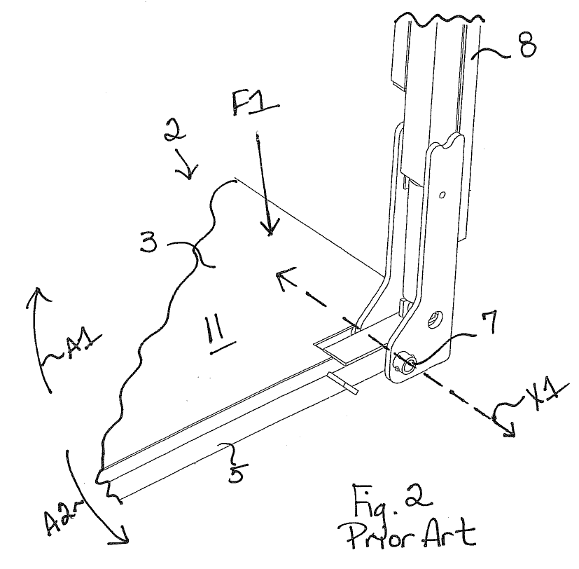

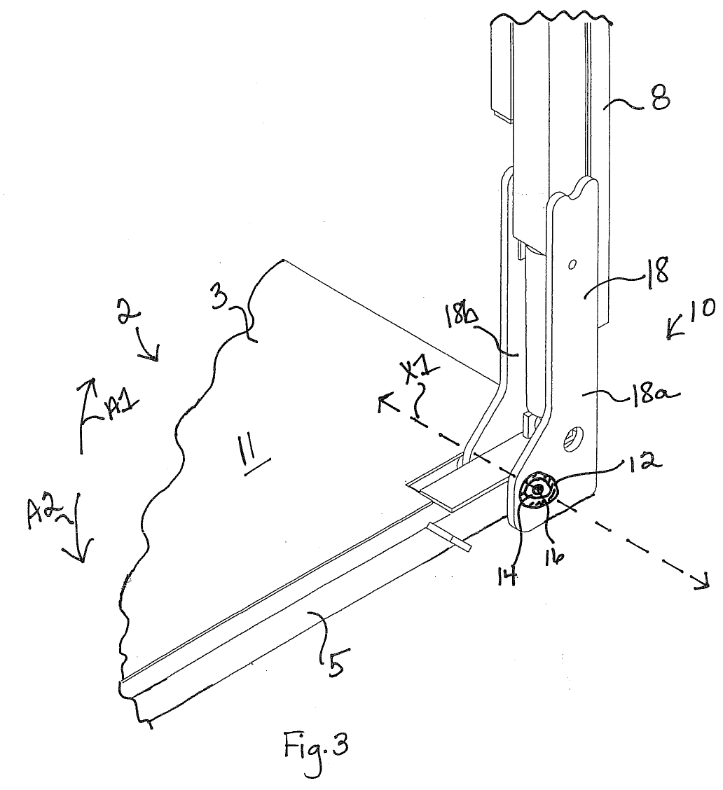

Referring now to the drawings wherein the showings are for purposes of illustrating embodiments of the invention only and not for purposes of limiting the same, FIGS. 3, 4A, 4B, 4C and 5 show one embodiment of an improved pivotal connection or providing increased degrees of freedom used with a liftgate. The general liftgate components are as discussed above and thus will not be re-explained here. It should be noted, however, that while the liftgate shown is the style known as rail type, this invention will work with any liftgate style, type and size, when applied with sound engineering judgment. The connection includes a pivoting ball joint connection 10 that includes a bushing member 12 and a ball member 14. The ball member has an opening 13 that receives a pin 16. The bushing member 12 may be received in a pair of holes formed in a bracket member 18 having first and second arms 18a, 18b and in the corresponding brace member 5 received between the arms 18a, 18b. It should be noted that the bushing member 12 is received in a manner substantially like the pivot pin 7 in FIGS. 1 and 2. The ball member 14 is received within the bushing member 12 in a known manner and the pin 16 is received within the opening 13 of the ball member 14 in a known manner.

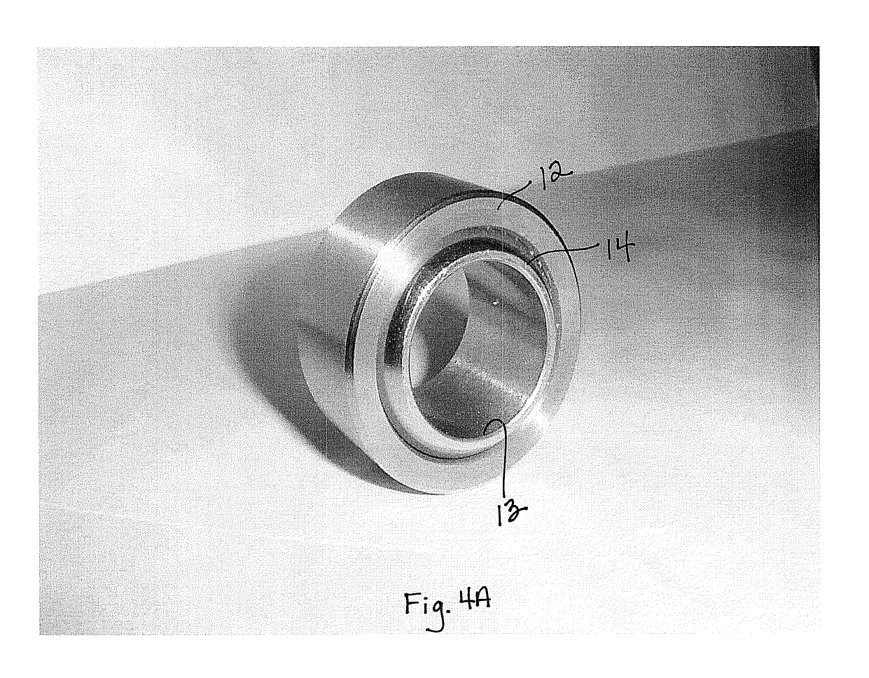

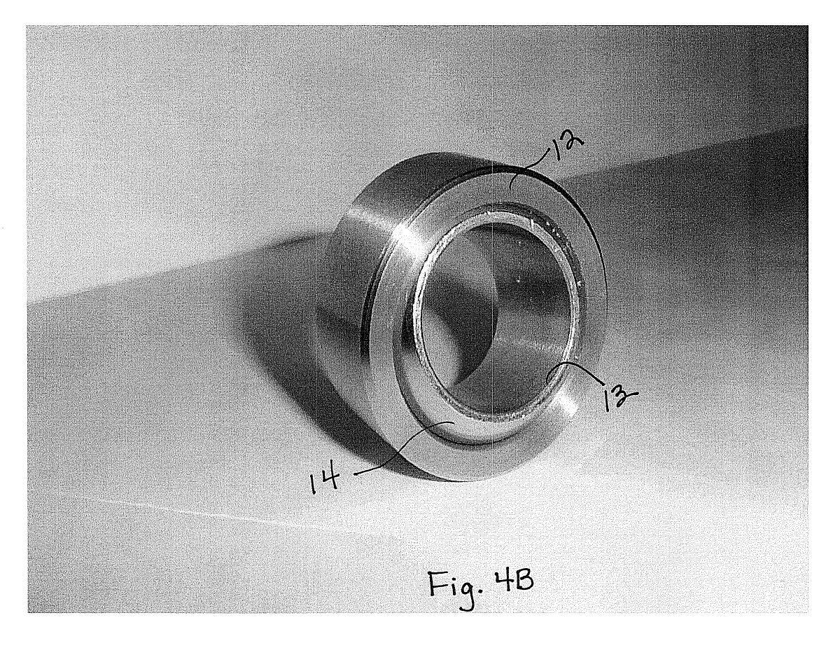

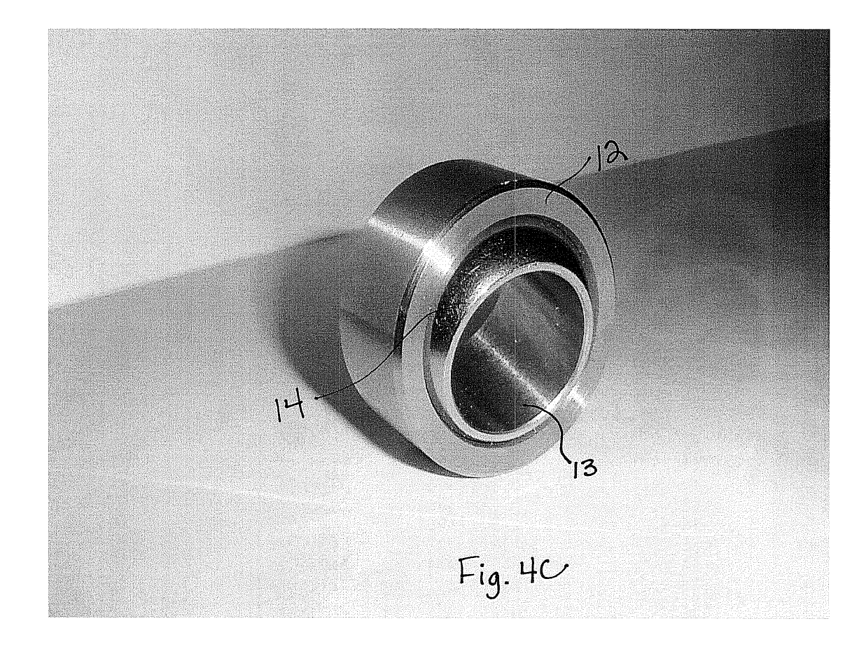

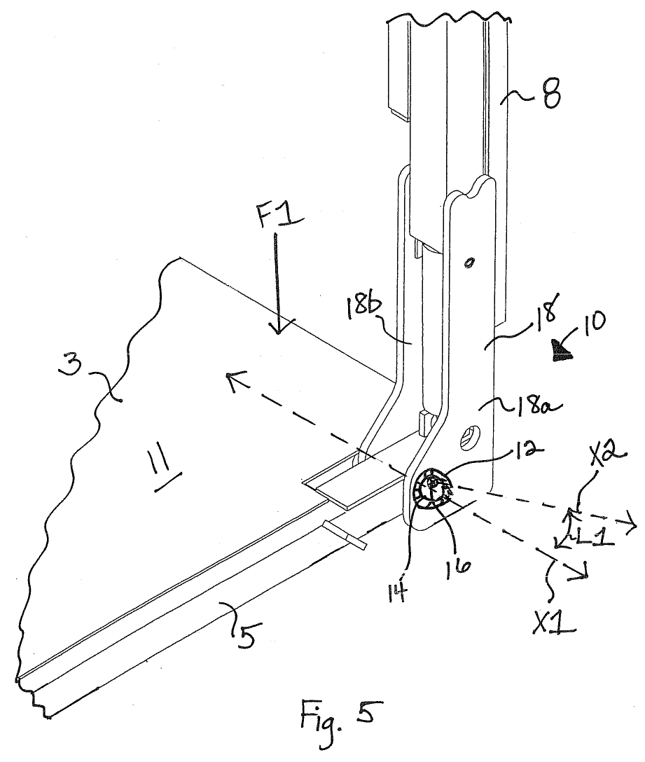

With continuing reference to FIGS. 3, 4A, 4B, 4C and 5, the pivoting ball joint connection 10 provides for pivotal motion of the platform assembly 2 about axis X1 of the pin 16 in directions A1 and A2 similar to that provided by the pivot pin 7 in FIGS. 1 and 2. The pivoting ball joint connection 10 also provides additional degrees of freedom, however. If, for example, the platform assembly 2 is loaded to create a force F1 sufficient to deflect the platform assembly 2, the ball member 14 moves within the bushing member 12 as shown in FIGS. 4B and 5. As a result, the pin 16 is moved within the pivoting ball joint connection 10 so that its resultant axis X2 is offset from its axis X1 by an angle L1. The motion along angle L1 provides additional degrees of freedom. When the force F1 is removed, the pin 16 will return to its initial position at axis X1. These extra degrees of freedom permit the platform assembly 2 to carry loads greater than those known in the prior art without the need to increase the weight and/or size and/or number of components. Note that the pivoting ball joint connection 10 may also provide for additional motion such as, for example, the motion shown in FIG. 4C.

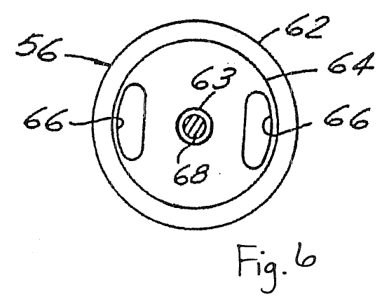

With reference now to FIG. 6, another embodiment improved pivotal connection providing increased degrees of freedom used with a liftgate will be described. The general liftgate components are as discussed above so the focus will be on the use of a voided bushing 56 for the connection. A voided bushing 56 may include outer and inner metal cylindrical tubes 62 and 63 confining an elastomeric bushing 64 therebetween. The tube 62 may be received in a pair of holes formed in the bracket member and the brace member similar to bushing member 12 described above. The tube 63 may receive pin 68 similar to how the ball member receives pin 16 as described above. Selectively located longitudinal openings or voids 66 are formed through the bushing 64. The elastomeric material may be varied in hardness, damping properties, and size, and variably voided by the openings 66, as required for proper tuning of the vertical and longitudinal load deflection rates of the liftgate assembly, as well as the lateral load deflection rate of the liftgate assembly. In one embodiment, the voids 66 are selected to provide a low lateral load deflection rate to allow for lateral displacement as the liftgate assembly encounters loads producing forces F1 as described above and to provide a high vertical load deflection rate to minimize other liftgate movement. This would provide for fewer degrees of freedom than provided by the pivoting ball joint connection 10 discussed above but, would provide more degrees of freedom than currently known in the art (see FIGS. 1 and 2).

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

I/We claim:

1. A liftgate assembly comprising:
a first rail member that may be fixedly attached to an associated vehicle;
a first manner they can be moved up and down along the first rail member;
a platform assembly comprising a platform supported to a platform support structure, the platform including a traffic surface for use in receiving traffic for loading and unloading cargo;
wherein the platform assembly is pivotally attached to the first runner with a first pivoting ball joint connection comprising: a bushing operatively connected to the first runner; a ball member rotatable within the bushing and having an opening; and, a pin received within the ball member opening and within a first opening formed in the first runner.

2. The liftgate assembly of claim 1 further comprising:
a second rail member that may be fixedly attached to an associated vehicle;
a second runner they can be moved up and down along the second rail member;
wherein the platform assembly is pivotally attached to the second runner with a second pivoting ball joint connection comprising: a bushing operatively connected to the second runner;
a ball member rotatable within the bushing and having an opening; and, a pin received within the ball member opening and within a second opening formed in the second runner.

3. The liftgate assembly of claim 1 wherein the first pivoting ball joint connection provides at least two degrees of freedom.

4. The liftgate assembly of claim 1 wherein the bushing is received within a pair of holes formed in a bracket member having first and second arms and in a brace member positioned between the first and second arms.

5. A liftgate assembly comprising:
a first rail member that may be fixedly attached to an associated vehicle;
a first runner they can be moved up and down along the first rail member;
a platform assembly comprising a platform supported to a platform support structure, the platform including a traffic surface for use in receiving traffic for loading and unloading cargo;
wherein the platform assembly is pivotally attached to the first runner with a first bushing comprising: an outer cylindrical tube operatively connected to the first runner; an inner cylindrical tube; an elastomeric bushing positioned between the outer and inner cylindrical tubes;
and a pin received within the inner cylindrical tube and within a first opening formed in the first runner.

6. The liftgate assembly of claim 5 wherein the elastomeric bushing has at least one void.

7. The liftgate assembly of claim 6 wherein the elastomeric bushing has a plurality of longitudinal voids.

8. The liftgate assembly of claim 6 wherein the void is selected to provide a low lateral load deflection rate.

9. The liftgate assembly of claim 5 further comprising:
a second rail member that may be fixedly attached to an associated vehicle;
a second runner they can be moved up and down along the second rail member;
wherein the platform assembly is pivotally attached to the second manner with a second bushing comprising: an outer cylindrical tube operatively connected to the second runner; an inner cylindrical tube; an elastomeric bushing positioned between the outer and inner cylindrical tubes; and a pin received within the inner cylindrical tube and within a second opening formed in the second runner.

10. The liftgate assembly of claim 5 wherein the first bushing provides at least two degrees of freedom.

11. The liftgate assembly of claim 5 wherein the first bushing is received within a pair of holes formed in a bracket member having first and second anus and in a brace member positioned between the first and second arms.
